(19) United States
(12) Patent Application Publication
(10) Pub. No.: US 2023/0030127 A1
(43) Pub. Date: Feb. 2, 2023

(54) PEOPLE FLOW PREDICTION DEVICE, PEOPLE FLOW PREDICTION METHOD, AND PEOPLE FLOW PREDICTION PROGRAM

(71) Applicant: NIPPON TELEGRAPH AND TELEPHONE CORPORATION, Tokyo (JP)

(72) Inventors: Keisuke TSUNODA, Tokyo (JP); Takahiro HATA, Tokyo (JP); Motonori NAKAMURA, Tokyo (JP); Kazuaki OBANA, Tokyo (JP)

(73) Assignee: NIPPON TELEGRAPH AND TELEPHONE CORPORATION, Tokyo (JP)

(21) Appl. No.: 17/788,185

(22) PCT Filed: Dec. 25, 2019
(86) PCT No.: PCT/JP2019/050951

§ 371 Date: Jun. 22, 2022

(51) Int. Cl. G06Q 10/04; G06V 20/52

(52) U.S. Cl. CPC G06Q 10/04; G06V 20/53

(57) ABSTRACT

A people flow prediction device includes a training data selection unit configured to select, in accordance with a prediction condition including a target prediction period subject to prediction, training data related to people flow data of a plurality of dates and times corresponding to the target prediction period, a prediction model creation unit configured to train, in accordance with the training data being selected, and store, in a model storage unit, a prediction model having a predetermined feature and for predicting people flow data of a predetermined date and time, and a prediction unit configured to select the prediction model from the model storage unit in accordance with the prediction condition and a permission condition related to a feature of the prediction model, and to predict people flow data under the prediction condition in accordance with the prediction model being selected.

### TECHNICAL FIELD

The disclosed technique relates to a people flow prediction device, a people flow prediction method, and a people flow prediction program.

### BACKGROUND ART

Prediction methods of a people flow for maintenance, management, and operation in public spaces, such as commercial facilities and passages, and optimization thereof include a method of statistically calculating and predicting a flow of people at times of congestion, such as when an event occurs.

### CITATION LIST

### Non Patent Literature

NPL 1: Ueda, Spatio-temporal Data Analysis for Realizing Ambient Intelligence, IEICE Communications Society Magazine, Vol. 45, pp. 21-28, 2018.

### SUMMARY OF THE INVENTION

### Technical Problem

The related art is a technique suitable for people flow prediction when a uniform flow of people occurs in a short period of time, such as when an event occurs. However, the flow of people in space changes variously and travel occurs in various directions and speeds, depending on the date and time. Thus, it is difficult to continually predict a people flow in a manner useful for the maintenance, management, and operation of commercial facilities or the like where various people come and go.

The disclosed technique has been made in light of the foregoing and an object thereof is to provide a people flow prediction device, a people flow prediction method, and a people flow prediction program capable of robustly predicting a flow of people in response to changes in space.

### Means for Solving the Problem

A first aspect of the present disclosure is a people flow prediction device including a training data selection unit that selects, in accordance with a prediction condition including a target prediction period subject to prediction, training data related to people flow data of a plurality of dates and times corresponding to the target prediction period, a prediction model creation unit that trains, in accordance with the training data being selected, and stores, in a model storage unit, a prediction model having a predetermined feature and for predicting people flow data of a predetermined date and time, and a prediction unit that selects the prediction model from the model storage unit in accordance with the prediction condition and a permission condition related to a feature of the prediction model and predicts people flow data under the prediction condition in accordance with the prediction model being selected.

### Effects of the Invention

According to the technique of the disclosure, a people flow can be robustly predicted in response to changes in space.

### BRIEF DESCRIPTION OF DRAWINGS

FIG. 1 is a block diagram illustrating a hardware configuration of a people flow prediction device according to the present embodiment.

FIG. 2 is a block diagram illustrating a functional configuration of the people flow prediction device according to the present embodiment.

FIG. 3 is a flowchart illustrating a sequence of people flow calculation processing performed by the people flow prediction device.

FIG. 4 is a flowchart illustrating a sequence of people flow prediction processing performed by the people flow prediction device.

FIG. 5 is a flowchart illustrating a sequence of selection processing of training data.

FIG. 6 is a configuration example according to an input and output of the people flow prediction device in a case in which the number of people traveling is predicted for each direction.

### DESCRIPTION OF EMBODIMENTS

Hereinafter, an example of embodiments of the technique disclosed herein will be described with reference to the drawings. In the drawings, the same reference signs are applied to the same or equivalent components and portions. The dimensional ratios in the drawings are exaggerated for convenience of explanation and may differ from actual ratios.

Hereinafter, a configuration of the present embodiment will be described. Note that the configuration and actions of the present embodiment will be described followed by description of examples of specific processing in first to third specific aspects of the present embodiment (hereinafter simply referred to as specific aspects).

### Configuration and Actions of Present Embodiment

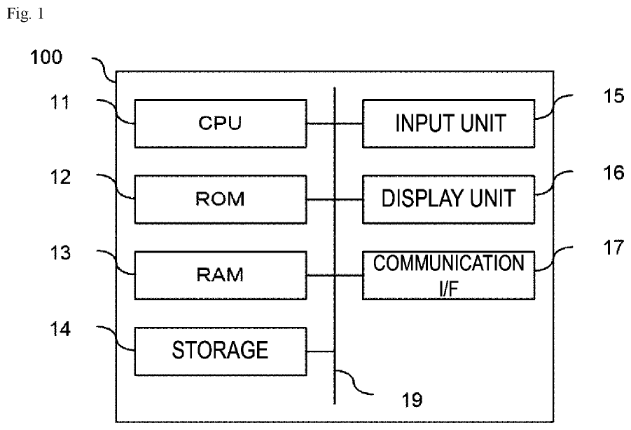

FIG. 1 is a block diagram illustrating a hardware configuration of a people flow prediction device 100 according to the present embodiment.

As illustrated in FIG. 1, the people flow prediction device 100 includes a central processing unit (CPU) 11, a read only memory (ROM) 12, a random access memory (RAM) 13, a storage 14, an input unit 15, a display unit 16, and a communication interface (I/F) 17. The components are communicably interconnected through a bus 19.

The CPU 11 is a central processing unit that executes various programs and controls each unit. In other words, the CPU 11 reads a program from the ROM 12 or the storage 14 and executes the program using the RAM 13 as a work area. The CPU 11 performs control of each of the components described above and various arithmetic processing operations in accordance with a program stored in the ROM 12 or the storage 14. In the present embodiment, a people flow calculation program and a people flow prediction program are stored in the ROM 12 or the storage 14.

The ROM 12 stores various programs and various kinds of data. The RAM 13 serves as a work area and temporarily stores programs or data. The storage 14 is configured with a storage device such as a hard disk drive (HDD) or a solid state drive (SSD) and stores various programs including an operating system and various kinds of data.

The input unit 15 includes a pointing device such as a mouse, and a keyboard and is used for performing various inputs.

The display unit 16 is, for example, a liquid crystal display and displays various kinds of information. The display unit 16 may employ a touch panel system and function as the input unit 15.

The communication interface 17 is an interface for communicating with other devices such as a terminal and uses standards such as, for example, Ethernet (trade name), fiber distributed data interface (FDDI), and Wi-Fi (trade name). The above is thus the hardware configuration of the people flow prediction device 100.

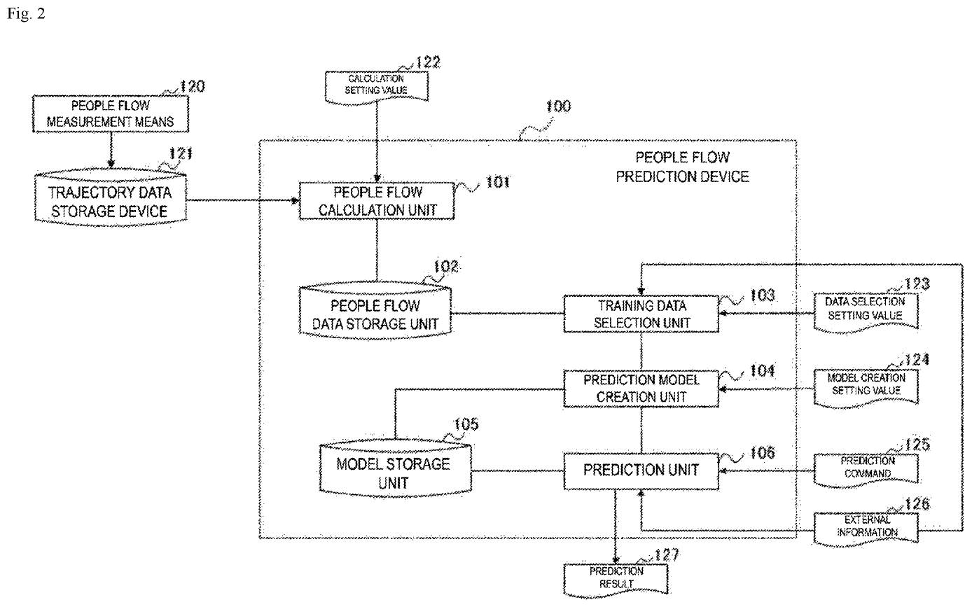

Next, each functional component of the people flow prediction device 100 will be described. FIG. 2 is a block diagram illustrating a functional configuration of the people flow prediction device 100 according to the present embodiment. Each functional component is implemented by the CPU 11 reading the people flow prediction program stored in the ROM 12 or the storage 14, and loading the people flow prediction program onto the RAM 13 to execute the program.

As illustrated in FIG. 1, the people flow prediction device 100 is configured to include a people flow calculation unit 101, a people flow data storage unit 102, a training data selection unit 103, a prediction model creation unit 104, a model storage unit 105, and a prediction unit 106. Functions that serve as input and output of the people flow prediction device 100 are a people flow measurement means 120, a trajectory data storage device 121, a calculation setting value 122, a data selection setting value 123, a model creation setting value 124, a prediction command 125, external information 126, and a prediction result 127.

Hereinafter, each component and input and output of the people flow prediction device 100 will be described.

The people flow measurement means 120 measures movement of people passing through a space using a sensor. In the measurement, the coordinates at which each person exists, its identifier (hereinafter referred to as a user ID), and a time point are simultaneously recorded at equal intervals as the movement of people in a space defined in a planar or three-dimensional manner. As a result, the movement of each person in the defined space is recorded. Note that, for the coordinates, for example, latitude and longitude information using a global positioning system (GPS) and coordinate information defined in the measurement means are used. Further, for the user ID, in addition to an ID registered in advance by the user into a system or the like, an ID automatically assigned by the people flow measurement means 120 may be used.

The trajectory data storage device 121 is a device such as a database that records the time point, the user ID, the coordinates, and an ID of the measured area measured by the people flow measurement means 120 as trajectory data. The measured area is a region defined as a plane or space of a desired shape in a coordinate system defined by the GPS or the people flow measurement means 120. In this way, the trajectory data is data that include coordinates for each time point of the traveling target.

The calculation setting value 122 is a setting value used by the people flow calculation unit 101. Examples of the setting value include a period of calculation, an area ID to be calculated, a rule for converting coordinate information accumulated in the trajectory data storage device 121 into directions of the people flow to be calculated, and a type of statistical value of speed to be calculated. Examples of the rules for conversion include, after setting the calculation direction to the four directions of north, south, east, and west, extracting only a direction of greatest travels among the latitudes and longitudes within the period from the trajectory data of each user ID, and determining north, south, east, or west in accordance with the extracted trajectory data. Further, examples of the statistical value of speed include a mean value, a standard deviation, and a maximum value. Thus, the calculation setting value 122 is a setting value including direction rules and a type to be calculated.

The people flow calculation unit 101 calculates the people flow data in accordance with the trajectory data input from the trajectory data storage device 121, and the calculation setting value 122 and stores the calculated data in the people flow data storage unit 102. As will be described in the specific aspects of the present embodiment described below, the people flow data calculated here assumes statistical value of the number of people traveling for each direction and a travel speed for each direction.

The data selection setting value 123 is a setting value used by the training data selection unit 103. Specifically, examples include a type of cross-validation used in the selection of training data (for example, n_fold or 1 day out), a type of evaluation value thereof (for example, mean absolute error), a minimum quantity and a maximum quantity of training data, and an initial value and a maximum value of before and after periods for training data selection.

The external information 126 is data other than the people flow data that may be included in the prediction model used for people flow prediction. Specifically, examples include weather for each date and time, calendar information, and date and time of event held in target area.

The training data selection unit 103 acquires the people flow data accumulated in the past in the people flow data storage unit 102 and the external information 126 in accordance with the prediction condition included in a data selection command input from the prediction model creation unit 104. The training data selection unit 103 selects the training data to be used for prediction model creation in accordance with the data selection setting value 123, and transmits the training data to the prediction model creation unit 104. Examples of methods of selecting training data include extracting features of several days before and after the prediction day, and then selecting data having similar features. For example, in order to predict Friday data, there is a method of selecting data in which the day before is a weekday, the current day is a weekday, and the day after is a weekend day. Details will be described in the specific aspects of the present embodiment.

Note that, as will be described below in the specific aspects, the training data selection unit 103 selects, as training data, each feature of the set that reduces the error obtained by cross-validation. The training data selection unit 103 calculates a feature vector related to δ days before and after the target prediction day. The training data selection unit 103 acquires, from among the people flow data of the predetermined condition, people flow data of δ days before and after having the same feature vector as the feature vector of the target prediction day, and external information corresponding to the people flow data. If the same feature vector does not exist, the people flow data of δ days before and after a similar feature vector are acquired. The training data selection unit 103 calculates each feature of the set of the acquired people flow data of δ days before and after and the external information, and selects the feature vector of δ days before and after and each feature of the set as training data. Here, for selection of the training data, the δ days before and after are incremented, each feature of the set is divided into for evaluation and for model creation to implement cross-validation, and each feature of the set that reduces the error to be obtained is selected from among the δ days before and after as training data. For example, when cases of performing cross-validation at δ=1 and δ=2 are compared, an error A of each feature of the set of one day before and after and an error B of each feature of the set of two days before and after are compared, each feature of the set that reduces the error is defined as the training data.

The model creation setting value 124 is a setting value used to create the prediction model. Specifically, examples include a prediction model creation timing, a target prediction day for using the created prediction model, and a type of prediction model.

The prediction model creation unit 104 trains a prediction model having a predetermined feature and for predicting people flow data of a predetermined date and time in accordance with the training data selected by the training data selection unit 103, and stores the prediction model in the model storage unit 105. When a model creation command is input from the prediction unit 106, the prediction model creation unit 104 transmits a data selection command, which is a command for selecting training data, to the training data selection unit 103. The prediction model creation unit 104 receives the training data from the training data selection unit 103, trains the prediction model in accordance with the received training data and the model creation setting value, and stores the prediction model in the model storage unit 105. Note that the prediction model in the present disclosure includes a linear model such as multiple regression, logistic regression, and partial least square (PLS) regression, a nonlinear model such as support vector regression (SVR), or a neural network such as a deep neural network (DNN), but is not limited to these models.

The model storage unit 105 is a database that stores the prediction model created by the prediction model creation unit, or the like.

The prediction command 125 is a command instructing the prediction unit 106 to predict a people flow, and includes a prediction condition and a permission condition. The prediction condition includes a target prediction period, an area ID indicating an area subject to prediction, a direction, and the number of people traveling or a travel speed as a prediction target to be predicted, and the like. The target prediction period specifies the day or date and time subject to prediction. The permission condition is a model selection method. The model selection method is, for example, a method of selecting a prediction model having a similar feature related to, for example, a classification of day, such as weekday, holiday, or national holiday. The model selection method is an example of a permission condition related to the feature of the prediction model of the present disclosure. The prediction condition and the permission condition will be described in the specific aspects of the present embodiment.

The prediction unit 106 acquires the people flow data from the people flow data storage unit 102 in accordance with the prediction command 125, subsequently selects the prediction model from the model storage unit 105, predicts the people flow data under the prediction condition in accordance with the selected prediction model, and outputs the prediction result 127. At this time, in a case in which a prediction model that can be used for prediction does not exist in the model storage unit 105, that is, in a case in which there is no prediction model that satisfies the prediction condition and the condition of the model selection method, the prediction unit 106 transmits the model creation command to the prediction model creation unit 104.

Next, the actions of the people flow prediction device 100 will be described. The actions will be described separately for people flow calculation processing and people flow prediction processing.

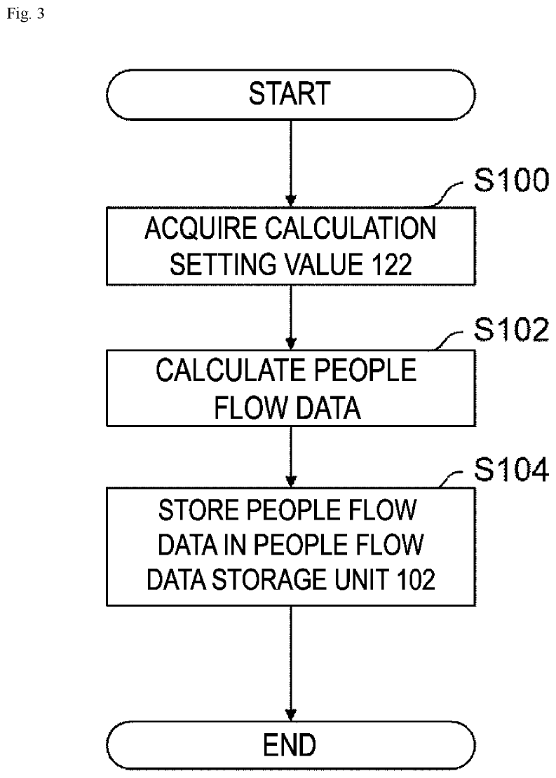

FIG. 3 is a flowchart illustrating a sequence of the people flow calculation processing performed by the people flow prediction device 100. The CPU 11 reads the people flow calculation program from the ROM 12 or the storage 14, loads the people flow calculation program onto the RAM 13, and executes the people flow calculation program, whereby the people flow calculation processing is performed. The CPU 11 executes the processing as each component of the people flow prediction device 100.

In step S100, the CPU 11, as the people flow calculation unit 101, acquires the calculation setting value 122. Examples of the acquisition method include a method of reading an externally prepared configuration file or transmitting some kind of defined signal from a terminal or the like to the people flow calculation unit 101, but is not limited to these methods.

In step S102, the CPU 11, as the people flow calculation unit 101, acquires the trajectory data from the trajectory data storage device 121 in accordance with the calculation setting value 122, and subsequently calculates the people flow data. Specifically, the CPU 11 acquires the trajectory data, to which the area ID of the calculation period is assigned, from the trajectory data storage device 121 according to the calculation setting value 122, and subsequently calculates the number of users traveling in the period or the statistical value of the travel speed of the users, for each set direction. Note that the CPU 11 establishes the people flow data by associating the calculation period and the area ID with the calculation result.

In step S104, the CPU 11, as the people flow calculation unit 101, stores the people flow data calculated in step S102 in the people flow data storage unit 102.

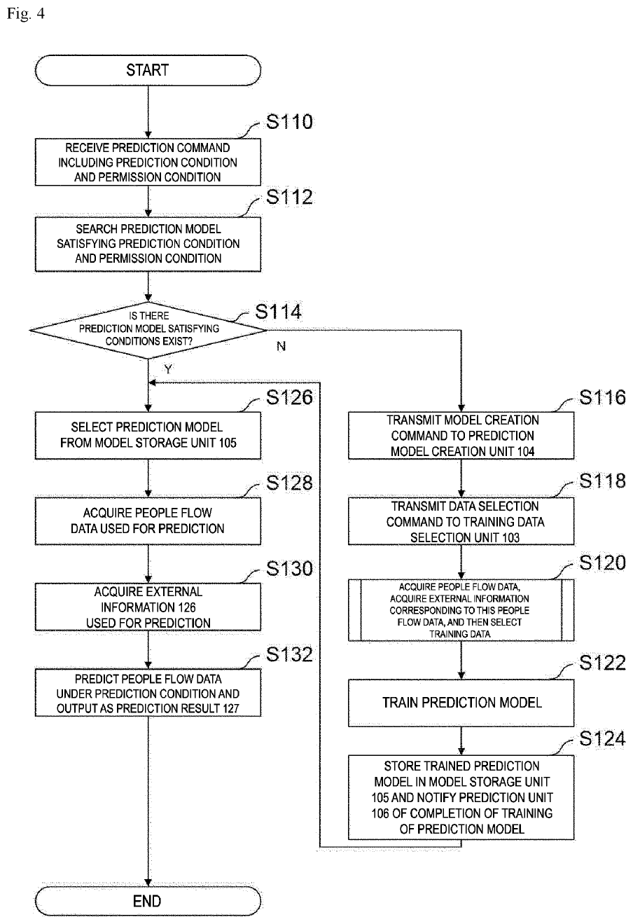

Next, the people flow prediction processing will be described. FIG. 4 is a flowchart illustrating a sequence of the people flow prediction processing performed by the people flow prediction device 100. The CPU 11 reads the people flow prediction program from the ROM 12 or the storage 14, loads the people flow prediction program onto the RAM 13, and executes the people flow prediction program, whereby the people flow prediction processing is performed. The CPU 11 executes the processing as each component of the people flow prediction device 100.

In step S110, the CPU 11, as the prediction unit 106, receives the prediction command 125 including the prediction condition and the permission condition. Examples of means for receiving the prediction command 125 include, but are not limited to, means for reception by a predefined signal using a communication protocol such as secure shell (SSH).

In step S112, the CPU 11, as the prediction unit 106, searches for a prediction model that satisfies the prediction condition and the permission condition from the model storage unit 105 in accordance with the prediction command 125.

In step S114, the CPU 11, as the prediction unit 106, determines whether a prediction model that satisfies the prediction condition and the permission condition exists in the search of step S112. The sequence proceeds to step S126 if a prediction model exists, and to step S116 if a prediction model does not exist.

In step S116, the CPU 11, as the prediction unit 106, transmits a model creation command to the prediction model creation unit 104 to create a prediction model.

In step S118, the CPU 11, as the prediction model creation unit 104, receives the model creation command and subsequently transmits a data selection command to the training data selection unit 103.

In step S120, the CPU 11, as the training data selection unit 103, selects and transmits the training data to the prediction model creation unit 104. Selection of the training data is performed after the data selection command is received, subsequently the people flow data from the people flow data storage unit 102 is acquired, and then the external information corresponding to the people flow data is acquired. The specific selection processing will be described below.

In step S122, the CPU 11, as the prediction model creation unit 104, trains a prediction model having a predetermined feature and for predicting people flow data of a predetermined date and time in accordance with the training data selected by the training data selection unit 103.

In step S124, the CPU 11, as the prediction model creation unit 104, stores the prediction model trained in the model storage unit 105, notifies the prediction unit 106 of completion of training of prediction model, and proceeds to step S126.

In step S126, the CPU 11, as the prediction unit 106, selects a prediction model that satisfies the prediction condition and the permission condition from the model storage unit 105 in accordance with the prediction command 125. In a case in which steps S116 to S124 are executed, the prediction model trained in the processing is selected. In a case in which a plurality of prediction models satisfy the prediction condition and the permission condition in the search in step S112, the prediction model that most satisfies the permission condition, for example, is selected.

In step S128, the CPU 11, as the prediction unit 106, acquires the people flow data used for prediction by the selected prediction model.

In step S130, the CPU 11, as the prediction unit 106, acquires the external information 126 used for prediction by the selected prediction model.

Note that the people flow data and the external information 126 used for prediction by the prediction model in steps S128 and S130 are targets corresponding to the features included in the selected prediction model. For example, in a case in which the people flow data and the air temperature for the same time point period two days before the prediction day and the same area ID are utilized as features of the prediction model, the CPU 11 acquires, from the people flow data storage unit 102, the people flow data for the period of the same time point two days before the target prediction day and the same area ID. Further, the CPU 11 acquires the air temperature of the period corresponding to the people flow data from the external information 126.

In step S132, the CPU 11, as the prediction unit 106, uses the acquired people flow data and the external information 126 as input to the selected prediction model, predicts the people flow data under the prediction condition, and outputs the prediction result 127.

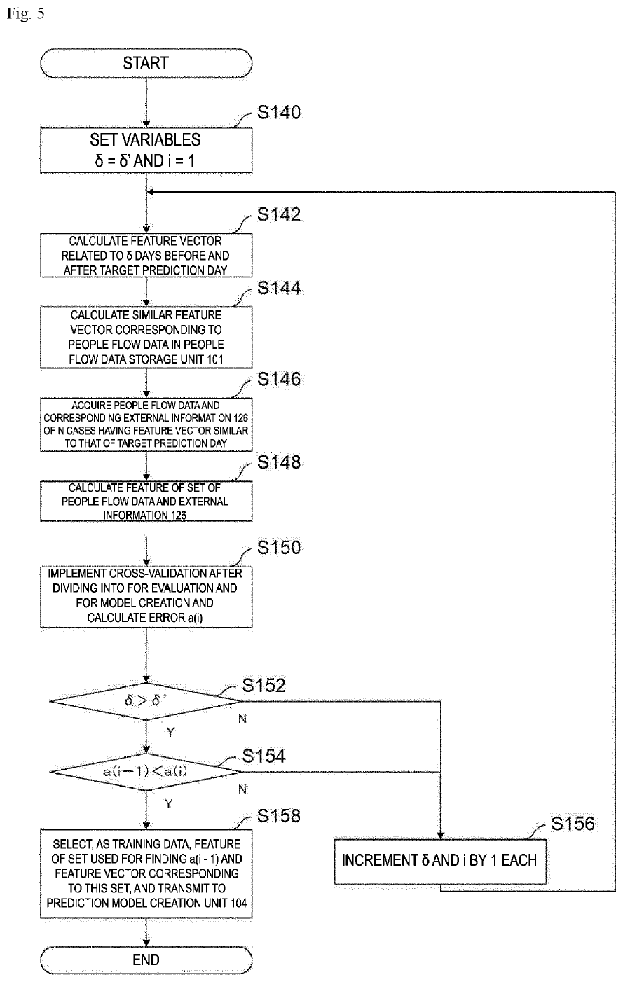

Next, details of the selection processing of training data in step S120 will be described. FIG. 5 is a flowchart illustrating a sequence of the selection processing of training data. The following processing is executed by the CPU 11 serving as the training data selection unit 103. The following processing is processing after the data selection command that includes information related to a setting value 6′ and the target prediction day is received from the prediction model creation unit 104.

In step S140, the CPU 11 sets variables δ=δ′ and i=1.

In step S142, the CPU 11 calculates a feature vector related to δ days before and after the target prediction day. As an example, if δ=1, the feature vector of one day before and after is calculated. In a case in which the feature is defined as weekday or holiday, given that holiday is represented by (1) and weekday is represented by (0), if the target prediction day is a weekday, the day before the target prediction day is a holiday, and the day after the target prediction day is a weekday, then the feature vector is [1, 0, 0].

In step S144, the CPU 11 calculates a feature vector in the same manner as in step S142 for the people flow data in the people flow data storage unit 102.

In step S146, the CPU 11 acquires N records of people flow data having a feature vector similar to that of the target prediction day, and the external information 126 corresponding to the N records of people flow data. To compare feature vectors, cosine similarity, for example, is used, but no such limitation is intended.

In step S148, the CPU 11 calculates each of the features of the sets of people flow data and the external information 126. Examples of the features include an average, a standard deviation, or the like obtained by creating categorical variables for weather information, namely, sunny, cloudy, and rainy, for the N records of people flow data. Specific examples of the features of a set are described below in the specific aspects.

In step S150, the CPU 11 divides each of the features of the sets into for evaluation and for model creation, implements cross-validation, and calculates an error a(i). As a result, an accuracy at the time of use of various combinations of features is calculated, making it possible to automatically determine an effectiveness of the features.

In step S152, the CPU 11 determines whether δ is greater than δ′ and proceeds to step S154 in a case in which δ is greater than δ′ or to step S156 in a case in which δ is not greater than δ′.

In step S154, the CPU 11 determines whether a(i−1) is less than a (i), and proceeds to step S158 in a case in which a(i−1) is less than a(i) or to step S156 in a case in which a(i−1) is not less than a(i).

In step S156, the CPU 11 increments δ and i by one each, and returns to step S142.

In step S158, the CPU 11 selects each feature of the set used to find a(i−1) and the feature vector corresponding to the set as training data, and transmits the training data to the prediction model creation unit 104.

As described above, in the selection processing of the training data, in a case in which the error a(i) obtained when the variable δ is increased and the target data are increased is compared with the error a(i−1) before the increase and the error a(i) is larger, the data of the error a(i−1) is adopted as the training data. As a result of this processing, the training data having the highest accuracy, that is, the smallest error between the features of the sets, is selected. Note that an upper limit of the variable δ may be defined.

### First Specific Aspect of Present Embodiment

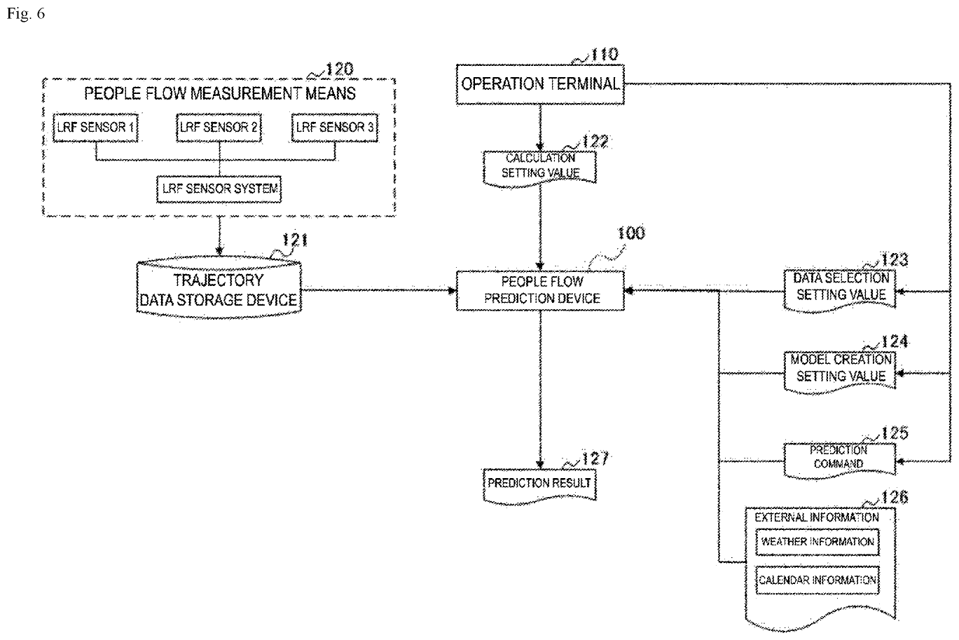

Next, the first specific aspect of the present embodiment will be described. The first specific aspect relates to a case in which the number of people traveling is predicted for each direction. The first specific aspect is an example of predicting a people flow within a certain defined area of passage within a commercial facility. FIG. 6 is a configuration example according to an input and output of the people flow prediction device 100 in a case in which the number of people traveling is predicted for each direction. The people flow measurement means 120 is configured as a laser range finder (LRF) sensor system in which a plurality of LRF sensors are installed. Weather information and calendar information are used as the external information 126. The various setting values are received from the operation terminal 110.

First, the people flow calculation processing will be described. Examples of the trajectory data are shown in Table 1.

TABLE 1

| Time | Area ID | User ID | X coordinate | Y coordinate |
|---|---|---|---|---|
| 2019 May 11-12:00:03 | 1F_1 | 0001 | 12321 | 22553 |
| 2019 May 11-12:00:04 | 1F_1 | 0001 | 12422 | 23552 |
| 2019 May 11-12:00:05 | 1F_1 | 0001 | 12523 | 24555 |
| 2019 May 11-12:00:06 | 1F_1 | 0001 | 12598 | 25558 |
| 2019 May 11-12:00:07 | 1F_1 | 0001 | 12616 | 26562 |
| 2019 May 11-12:00:01 | 1F_1 | 0002 | 12619 | 25553 |
| 2019 May 11-12:00:02 | 1F_1 | 0002 | 12532 | 24552 |
| 2019 May 11-12:00:03 | 1F_1 | 0002 | 12487 | 23555 |
| 2019 May 11-12:00:04 | 1F_1 | 0002 | 12305 | 22558 |
| . . . | | | | |

The data in Table 1 includes the measurement time point including the date, the area ID, the user ID, and the X coordinate and the Y coordinate indicating the position of each user. Note that the X coordinate and the Y coordinate are relative coordinates that can be set by the LRF sensor system, the X axis and the Y axis correspond to east-west and north-south, respectively, and the unit is mm. The trajectory data including such data are assumed to be stored in the trajectory data storage device 121 for a plurality of days and a plurality of users.

In the following, description is made in the sequence of the flowchart of actions described above. First, the people flow calculation unit 101 receives the following information from the operation terminal 110 as the calculation setting value 122 in SSH (equivalent to step S100; hereinafter the same).
Target calculation period: 5/11/2019, from 7:00:00 to 23:00:00
Calculation interval: 30 minutes
Target calculation area: 1F_1
Direction: North and South
Direction calculation rule: Axis of greatest travel only
Type of calculation target: Total number of people passing

Upon receiving the calculation setting value 122, the people flow calculation unit 101 acquires, from the trajectory data storage device 121, the trajectory data of 1F_1 from 7:00:00 to 23:00:00 on 5/11/2019. Then, for each 30-minute period of 7:00:00 to 7:29:59, 7:30:00 to 7:59:59, . . . , the people flow calculation unit 101 calculates, as the people flow data, the total number of people passing in the set directions according to the trajectory data within the period. Focusing on the data from 12:00:00 to 12:29:59 and using the trajectory data of the two users in Table 1 as an example, the user of ID 0001 travels 295 mm in the X direction and 4009 mm in the Y direction over four seconds. In this case, the direction calculation rule is “axis of greatest travel only” and thus the people flow calculation unit 101 determines that the user of ID 0001 traveled in the positive direction of the Y axis, that is, northward, which is the direction of greatest travel, and counts the user as one person passing northward. The user of ID 0002 moves −314 mm in the X direction and −2995 mm in the Y direction over three seconds and, in this case, the people flow calculation unit 101 determines that the user of ID 0002 has traveled in the negative direction of the Y axis, that is, southward, which is the direction of greatest travel, and counts the user as one person passing southward. In this manner, the people flow calculation unit 101 applies the calculation described above to the trajectory data of each period for each unique ID, and calculates the total numbers of people passing northward and southward (step S102). Note that, in the case of a user who travels the greatest amount in the X-axis direction, the direction is east-west and does not match the “Direction: North, South” of the calculation setting value 122 and thus the user is excluded from the calculation of the number of people passing. However, in a case in which the direction calculation rule is not particularly specified, the number of people may be calculated by focusing on and using only the direction of the Y axis with the greatest travel.

Table 2 shows an example of the people flow data of the calculated number of people passing.

TABLE 2

| | | Area | Number of people | Number of people |
|---|---|---|---|---|
| Start time | End time | ID | passing northward | passing southward |
| 2019 May 11-7:00:00 | 2019 May 11-7:29:59 | 1F_1 | 3 | 10 |
| 2019 May 11-7:30:00 | 2019 May 11-7:59:59 | 1F_1 | 25 | 74 |
| 2019 May 11-8:00:00 | 2019 May 11-8:29:59 | 1F_1 | 152 | 486 |
| . . . | | | | |
| 2019 May 11-22:30:00 | 2019 May 11-22:59:59 | 1F_1 | 28 | 4 |

As shown in Table 2, the people flow calculation unit 101 stores the people flow data in the people flow data storage unit 102 using a data structure of period (start time point and end time point), area ID, and numbers of people passing northward and southward (step S104).

Next, the people flow prediction processing will be described. It is assumed that there are no prediction models stored in the model storage unit 105 and that the people flow data of every 30 minutes from 7:00:00 to 23:00:00 from 5/11/2019 to 10/31/2019, calculated by the method described above, are saved in the people flow data storage unit 102. First, the operation terminal 110 transmits the following prediction command 125 to the prediction unit 106 in SSH (step S110).
Target prediction period: 11/5/2019
Prediction interval: 30 minutes
Target prediction area: 1F_1
Direction: North and South
Type of prediction target: Total number of people passing
Model selection method: Prediction model having similar weekdays and holidays one day before and after the target day
Maximum permitted distance for model selection: 0.25

The prediction command 125 is divided into the prediction condition and the permission condition. The prediction condition includes target prediction period, prediction interval, target prediction area, and type of prediction target. The permission condition includes model selection method and maximum permitted distance for model selection. Note that the maximum permitted distance for model selection is a setting value for newly creating a prediction model in a case in which a distance between a prediction target and a prediction model is calculated for prediction model selection and there is no prediction model of that value or less. That is, the permission condition is defined as a distance of the feature vector related to the days before and after included in the prediction model from the feature vector related to the days before and after the day specified in the target prediction period of the prediction condition.

Upon receiving the prediction command 125, the prediction unit 106 first searches for a prediction model that satisfies the prediction condition and the maximum permissible distance for model selection of 0.25 in the model storage unit 105 (S112). First, as a narrowing down by the prediction condition, narrow down to prediction models that match the target prediction period, the area ID, and the type of prediction target included in the prediction command 125. Here, it is assumed that the prediction models shown in Table 3 are stored in the model storage unit 105.

TABLE 3

| | | | | Model of | | | Coefficient | | | | Coefficient | |
|---|---|---|---|---|---|---|---|---|---|---|---|---|
| | | Feature | Area | prediction | Prediction | | of variable | | Prediction | | of variable | |
| ID | Model feature | vector | ID | target 1 | target 1 | Variable 1 | 1 | . . . | target 2 | Variable 1 | 1 | . . . |
| 1 | Holiday and | [0, 0, 0] | 1F_1 | PLS | Number of | Average | 0.24 | | Number of | Average | 0.32 | |
| | weekday before | | | regression | passing | number of | | | passing | number of | | |
| | and after target | | | | northward | people passing | | | southward | people passing | | |
| | day | | | | | northward | | | | southward | | |
| 2 | Holiday and | [0, 0, 0] | 2F_1 | Logistic | Number of | Average | 0.54 | | Number of | Average | 0.75 | |
| | weekday before | | | regression | passing | number of | | | passing | number of | | |
| | and after target | | | | northward | people passing | | | southward | people passing | | |
| | day | | | | | northward | | | | southward | | |
| 3 | Holiday and | [0, 0, 1] | 1F_1 | SVR | Number of | Average | −0.38 | | Number of | Average | 0.26 | |
| | weekday before | | | | passing | number of | | | passing | number of | | |
| | and after target | | | | northward | people passing | | | southward | people passing | | |
| | day | | | | | southward | | | | southward | | |

The model features shown in Table 2 are feature vectors related to the days before and after included in the prediction model. In this case, the prediction models of ID 1 and ID 3 included in Table 2 are targeted. Next, the prediction model is selected from the prediction models obtained from the narrowing down in accordance with the model selection method and the maximum permissible distance for model selection. 11/5/2019, that is the target prediction period, is Tuesday, and it is assumed that 11/4, that is the day before, is a national holiday, and 11/6, that is the day after, is a weekday. Therefore, the feature vector is calculated as [1, 0, 0]. When the average distance between the feature vectors of the target prediction period and the prediction model are calculated, the distance is 0.33 for the prediction model of ID 1 and 0.66 for the prediction model of ID 3. These values are determined not to satisfy the maximum permissible distance for model selection (step S114). The prediction unit 106 transmits the following model creation command to the prediction model creation unit 104 (step S116).
Target prediction period: 11/5/2019
Prediction interval: 30 minutes
Target prediction area: 1F_1
Direction: North and South
Type of prediction target: Total number of people passing
Model selection method: Model having similar holidays and weekdays δ days before and after the target day
δ′=1, N=10

The prediction model creation unit 104 receives the model creation command described above and subsequently transmits a data selection command similar to the model creation command to the training data selection unit 103 (step S118).

Upon receiving the data selection command described above, the training data selection unit 103 performs processing for selecting training data for prediction model creation (step S120). The processing for selecting training data first sets the initial values of variables δ and i to variables δ=δ′, i=1 (step S140). The training data selection unit 103, upon acquiring the calendar information of the external information 126, calculates a feature vector indicating the weekdays and holidays δ days before and after the target prediction day (step S142).

Next, the training data selection unit 103 calculates the feature vector of the people flow data (step S144). Here, the training data selection unit 103 first conducts a search to identify if the people flow data storage unit 102 includes people flow data of the total numbers of people passing northward and southward in area 1F_1 before 11/5/2019 in accordance with the prediction condition of the data selection command. An example of the people flow data obtained by the search is shown in Table 4.

TABLE 4

| | | Area | Number of people | Number of people |
|---|---|---|---|---|
| Start time | End time | ID | passing northward | passing southward |
| 2019 May 11-7:00:00 | 2019 May 11-7:29:59 | 1F_1 | 3 | 10 |
| 2019 May 11-7:30:00 | 2019 May 11-7:59:59 | 1F_1 | 25 | 74 |
| 2019 May 11-8:00:00 | 2019 May 11-8:29:59 | 1F_1 | 152 | 486 |
| . . . | . . . | | | |
| 2019 Oct. 31-22:30:00 | 2019 Oct. 31-22:59:59 | 1F_1 | 24 | 12 |

It is assumed that people flow data satisfying the prediction condition from 5/11/2019 to 10/31/2019 such as shown in Table 4 are accumulated in the people flow data storage unit 102. The training data selection unit 103 calculates, as a feature vector, weekdays and holidays δ=1 day before and after each day of the people flow data satisfying the prediction condition in the people flow data storage unit 102.

The training data selection unit 103 acquires the people flow data having a feature vector similar to that of the target prediction day, and the external information 126 (step S146). N=10 and therefore the training data selection unit 103 acquires ten records of people flow data having a similar feature vector and ten records of weather information (sunny, cloudy, rainy) of the external information 126 corresponding to the same dates. For example, in the case of 11/5/2019, the feature vector is [1, 0, 0] and thus the training data selection unit 103 selects ten records of people flow data from 5/11 to 10/31 having a feature vector matching this feature vector. In a case in which there are more than ten records of people flow data having a feature vector that matches that of the target prediction day, the training data selection unit 103 acquires the first ten records of people flow data in reverse chronological order from the target prediction day. For example, 10/28, 10/23, 10/15, 10/7, 9/30, 9/17, 9/9, 9/2, 8/26, 8/19 or the like are selected.

Then, the training data selection unit 103 calculates each of the features of the sets of the acquired people flow data of δ days before and after and the external information 126 (weather information) (step S148). An example of the features of the sets is shown in Table 5.

TABLE 5

| | | | Average | Average | Average | Average | Standard | Standard | Standard | Standard |
|---|---|---|---|---|---|---|---|---|---|---|
| | | | number of | number of | number of | number of | deviation of | deviation of | deviation of | deviation of |
| | | | people | people | people | people | number of | number of | number of | number of |
| | | | passing | passing | passing | passing | people passing | people passing | people passing | people passing |
| Start | | Area | northward | southward | northward | southward | northward | southward | northward | southward |
| time | End time | ID | (sunny) | (sunny) | (rainy) | (rainy) | (sunny) | (sunny) | (rainy) | (rainy) |
| 7:00:00 | 7:29:59 | IF_1 | 3.2 | 9.7 | 3.1 | 7.8 | 0.24 | 0.52 | 0.03 | 0.16 |
| 7:30:00 | 7:59:59 | IF_1 | 22.4 | 73.2 | 18.9 | 67.2 | 4.21 | 6.21 | 0.24 | 4.74 |
| 8:00:00 | 8:29:59 | IF_1 | 152.5 | 418.4 | 157.3 | 318.4 | 9.48 | 24.42 | 23.13 | 32.13 |
| . . . | | | | | | | | | | |
| 22:30:00 | 22:59:59 | IF_1 | 26.2 | 4.5 | 25.2 | 3.5 | 2.25 | 0.85 | 2.22 | 0.55 |

The training data selection unit 103 calculates the features on a per set basis with each set obtained by dividing the ten days' worth of features into the features of each day. Table 5 shows the feature of a set for one day. That is, given δ=1, the training data selection unit 103 calculates the feature of a set related to a certain day using the people flow data and the weather information for the three days of the day before, the current day, and the day after. The features of sets are thus calculated separately for each day because it is necessary to divide the features into for evaluation and for model creation in order to carry out cross-validation. Accordingly, the features may not be divided by units of one day. As shown in Table 5, the features of the sets are obtained by defining the rows as 30-minute intervals from 7:00:00 to 23:00:00. Further, the average number of people passing and the standard deviation of the number of people passing are calculated when, as the features of the sets, direction is divided into northward and southward, and the weather is divided into sunny, cloudy, and rainy, for each day.

Next, the training data selection unit 103 calculates the error a(i). In the present embodiment, the training data selection unit 103 divides the acquired sets of data of ten records into a portion for evaluation and the remainder for model creation, and then implements cross-validation on each feature of the sets to calculate the error a(i). For example, for the ten sets of features covering ten days, the training data selection unit 103 defines the features of one day as those for evaluation and the features of the remaining nine days as those for model creation. The training data selection unit 103 implements cross-validation by exchanging those for evaluation and those for model creation for all dates (referred to as one day out cross validation). In this example, a total of ten patterns of cross-validation are implemented and ten types of accuracy are calculated, and thus the training data selection unit 103 calculates the average accuracy of these as the error a(i) (step S150).

Here, it is assumed that PLS regression is used for evaluation, the accuracy is the mean absolute error between the evaluation value of those for evaluation and the prediction value of those for model creation, and error a(1)=0.25 is calculated. The first time is δ equals δ′ and δ is not greater than δ′, and thus the processing proceeds to step S156, and increments of i=i+1=2 and δ=δ+1=2 are performed (steps S152 to S156). Next, the training data selection unit 103 performs data selection and error a(2) calculation for the case of δ=2 (steps S142 to S150). As a result, given that the error a(2) is calculated as 0.32, then δ(2)>δ′(1) and a(i−1)<a(i). Therefore, the training data selection unit 103 transmits, to the prediction model creation unit 104, each of the features of the ten data records (10/28, 10/23, 10/15, 10/7, 9/30, 9/17, 9/9, 9/2, 8/26, 8/19) used to find a(i−1) (step S158).

The prediction model creation unit 104 receives the training data and subsequently once again creates a prediction model that predicts the most recent record (10/28) of the ten records using the remaining nine records by the PLS regression model. The prediction model creation unit 104 stores the features (feature name) of the prediction model and the coefficient of the features in the model storage unit 105 and simultaneously notifies the prediction unit 106 of calculation completion (step S124). An example in which the prediction model is added to the model storage unit 105 is shown in Table 6. ID 4 is the prediction model additionally stored.

TABLE 6

| | | | | Model of | | | Coefficient | | | | Coefficient | |
|---|---|---|---|---|---|---|---|---|---|---|---|---|
| | | Feature | Area | prediction | Prediction | | of variable | | Prediction | | of variable | |
| ID | Model feature | vector | ID | target 1 | target 1 | Variable 1 | 1 | . . . | target 2 | Variable 1 | 1 | . . . |
| 1 | Holiday and | [0, 0, 0] | 1F_1 | PLS | Number of | Average | 0.24 | | Number of | Average | 0.32 | |
| | weekday | | | regression | passing | number of | | | passing | number of | | |
| | before and | | | | northward | people passing | | | southward | people passing | | |
| | after target day | | | | | northward | | | | southward | | |
| 2 | Holiday and | [0, 0, 0] | 2F_1 | Logistic | Number of | Average | 0.54 | | Number of | Average | 0.75 | |
| | weekday | | | regression | passing | number of | | | passing | number of | | |
| | before and | | | | northward | people passing | | | southward | people passing | | |
| | after target day | | | | | northward | | | | southward | | |
| 3 | Holiday and | [0, 0, 1] | 1F_1 | SVR | Number of | Average | −0.38 | | Number of | Average | 0.26 | |
| | weekday | | | | passing | number of | | | passing | number of | | |
| | before and | | | | northward | people passing | | | southward | people passing | | |
| | after target day | | | | | southward | | | | southward | | |
| 4 | Holiday and | [1, 0, 0] | 1F_1 | PLS | Number of | Average | 0.31 | | Number of | Average | 0.35 | |
| | weekday | | | regression | passing | number of | | | passing | number of | | |
| | before and | | | | northward | people passing | | | southward | people passing | | |
| | after target day | | | | | northward | | | | southward | | |
| | | | | | | (sunny) | | | | (sunny) | | |

Next, the prediction unit 106 receives the notification and subsequently acquires, from the model storage unit 105, the prediction model of ID 4, which is a prediction model satisfying the prediction condition and the permission condition (step S126). Furthermore, the prediction unit 106 acquires, from the people flow data storage unit 102, the numbers of people passing northward and southward on the day that is the day before the feature vector is a holiday, the current day is a weekday, and the day after the feature vector is a weekday, which is the condition included in the prediction model (step S128). Here, the people flow data of each date of the features used to train the prediction model are targeted. Then, the prediction unit 106 acquires the weather information of the external information 126 for the same days that satisfy the conditions (step S128). Next, the prediction unit 106 predicts the number of passing people in accordance with the prediction model (step S130). Here, the prediction unit 106 first calculates the average number of people passing and the standard deviation of the number of people passing when the acquired people flow data of the respective dates included in the prediction model are divided by day and by weather (sunny, cloudy, rainy) for northward and southward, in 30-minute intervals from 7:00:00 to 23:00:00 and then carries out the prediction. The prediction unit 106 predicts the numbers of people passing northward and southward at 30-minute intervals from 7:00:00 to 23:00:00 on 11/5, which is the target prediction period, with a PLS regression model using coefficients for each feature, which is the acquired prediction model, and outputs the numbers as the prediction result 127. The output prediction result 127 may be stored in some kind of storage device (not illustrated).

This concludes the description of the first specific aspect of the present embodiment.

### Second Specific Aspect of Present Embodiment

Next, the second specific aspect will be described. The second specific aspect is a case in which a travel speed is predicted for each direction. In the second specific aspect, only the differences from the first specific aspect will be described.

The people flow calculation unit 101 is assumed to receive the following information from the operation terminal 110 by SSH as the calculation setting value 122 (step S100). The second specific aspect differs from the first specific aspect in that the type of calculation target is average speed.
Target calculation period: 5/11/2019, from 7:00:00 to 23:00:00
Calculation interval: 30 minutes
Target calculation area: 1F_1
Direction: North and South
Direction calculation rule: Axis of greatest travel only
Type of calculation target: Average speed

For each 30-minute period, the people flow calculation unit 101 calculates, as the people flow data, the average speed in the set directions according to the trajectory data in the period. With a focus on the data from 12:00:00 to 12:29:59, the people flow calculation unit 101 finds the average speed for the two users given in Table 1. The user of ID 0001 moves 295 mm in the X direction and 4009 mm in the Y direction over four seconds, and, in this case, the people flow calculation unit 101 determines that the user of ID 0001 has traveled in the positive direction of the Y axis, that is, northward, which is the direction of greatest travel, and sets the passing speed to 1002.25 mm/sec. The user of ID 0002 moves −314 mm in the X direction and −2995 mm in the Y direction over three seconds, and, in this case, the people flow calculation unit 101 determines that the user of ID 0002 has traveled in the negative direction of the Y axis, that is, southward, which is the direction of greatest travel, and sets the passing speed to 998.33 mm/sec. In this manner, the people flow calculation unit 101 applies the calculation described above to the trajectory data of each period for each unique ID, and calculates, as the people flow data, the average speeds northward and southward.

Examples of the people flow data of the calculated average speed are shown in Table 7.

TABLE 7

| | | | Northward | Southward |
|---|---|---|---|---|
| Start time | End time | Area ID | average speed | average speed |
| 2019 May 11-7:00:00 | 2019 May 11-7:29:59 | 1F_1 | 976.21 | 790.53 |
| 2019 May 11-7:30:00 | 2019 May 11-7:59:59 | 1F_1 | 974.21 | 983.11 |
| 2019 May 11-8:00:00 | 2019 May 11-8:29:59 | 1F_1 | 1032.36 | 1203.33 |
| . . . | | | | |
| 2019 May 11-22:30:00 | 2019 May 11-22:59:59 | 1F_1 | 879.53 | 789.55 |

The people flow data retrieved in step S146 are as shown in Table 8.

TABLE 8

| | | | Northward | Southward |
|---|---|---|---|---|
| Start time | End time | Area ID | average speed | average speed |
| 2019 May 11-7:00:00 | 2019 May 11-7:29:59 | 1F_1 | 976.21 | 790.53 |
| 2019 May 11-7:30:00 | 2019 May 11-7:59:59 | 1F_1 | 974.21 | 983.11 |
| 2019 May 11-8:00:00 | 2019 May 11-8:29:59 | 1F_1 | 1032.36 | 1203.33 |
| . . . | | | | |
| 2019 Oct. 31-22:30:00 | 2019 Oct. 31-22:59:59 | 1F_1 | 899.53 | 735.55 |

The processing of the subsequent steps is the same as that of the first specific aspect with the type of calculation target set as the average speed in each command.

### Third Specific Aspect of Present Embodiment

Next, the third specific aspect will be described. The third specific aspect is a case in which weather information is used in the model selection method. In the third specific aspect, only the differences from the first specific aspect will be described.

In the first and second specific aspects, weekdays and holidays δ days before and after the target prediction day are used as the feature vector, and the prediction unit 106 and the training data selection unit 103 adopt a model selection method using the feature vector. In the third specific aspect, an example is given in which the weather information of the external information 126 is used as another example of a feature vector and the weather information of δ days before and after the target prediction day is used as the feature vector. Here, the weather of one day refers to the weather that lasts the longest during that one day, given 0 as sunny, 1 as cloudy, and 2 as rainy.

The prediction unit 106 transmits the following model creation command to the prediction model creation unit 104 (step S116).
Target prediction period: 11/5/2019
Prediction interval: 30 minutes
Target prediction area: 1F_1
Direction: North and South
Type of prediction target: Total number of people passing
Model selection method: Prediction model having similar weather information of one day before and after the target day
δ′=1, N=10

Here, it is assumed that the prediction models shown in Table 9 are stored in the model storage unit 105.

TABLE 9

| | | | | Model of | | | Coefficient | | | | Coefficient | |
|---|---|---|---|---|---|---|---|---|---|---|---|---|
| | | Feature | Area | prediction | Prediction | | of variable | | Prediction | | of variable | |
| ID | Model feature | vector | ID | target 1 | target 1 | Variable 1 | 1 | . . . | target 2 | Variable 1 | 1 | . . . |
| 1 | Weather before | [0, 0, 0] | 1F_1 | PLS | Number of | Average | 0.24 | | Number of | Average | 0.32 | |
| | and after target | | | regression | passing | number of | | | passing | number of | | |
| | day | | | | northward | people passing | | | southward | people passing | | |
| | | | | | | northward | | | | southward | | |
| 2 | Holiday and | [0, 0, 0] | 2F_1 | Logistic | Number of | Average | 0.54 | | Number of | Average | 0.75 | |
| | weekday | | | regression | passing | number of | | | passing | number of | | |
| | before and after | | | | northward | people passing | | | southward | people passing | | |
| | target day | | | | | northward | | | | southward | | |
| 3 | Weather before | [0, 0, 1] | 1F_1 | SVR | Number of | Average | −0.38 | | Number of | Average | 0.26 | |
| | and after target | | | | passing | number of | | | passing | number of | | |
| | day | | | | northward | people passing | | | southward | people passing | | |
| | | | | | | southward | | | | southward | | |

Given that 11/5/2019, that is the target prediction day, is rainy, 11/4, that is the day before, is sunny, and forecast of 11/6, that is the day after, is rainy, the feature vector is [0, 2, 2]. When the average distance between the feature vectors of the prediction target and the prediction models are calculated, the distance is 1.33 for ID 1 and 1.0 for ID 3. These values are determined not to satisfy the maximum permissible distance for model selection (step S114). The prediction unit 106 transmits the following model creation command to the prediction model creation unit 104 (step S116).
Target prediction period: 11/5/2019
Prediction interval: 30 minutes
Target prediction area: 1F_1
Direction: North and South
Type of prediction target: Total number of people passing
Model selection method: Model having similar weather information of δ days before and after the target day
δ′=1, N=10

The training data selection unit 103, upon acquiring the weather information of the external information 126, calculates a feature vector indicating the weather information of one day before and after the target prediction day (step S142). Further, the training data selection unit 103 calculates, as a feature vector, the weather information of δ=1 day before and after each day of the people flow data satisfying the prediction condition in the people flow data storage unit 102 (step S144). Then, the training data selection unit 103 similarly selects the training data.

An example in which the prediction model is added to the model storage unit 105 in step S124 is shown in Table 10. ID 4 is the prediction model additionally stored.

TABLE 10

| | | | | Model of | | | Coefficient | | | | Coefficient | |
|---|---|---|---|---|---|---|---|---|---|---|---|---|
| | | Feature | Area | prediction | Prediction | | of variable | | Prediction | | of variable | |
| ID | Model feature | vector | ID | target 1 | target 1 | Variable 1 | 1 | . . . | target 2 | Variable 1 | 1 | . . . |
| 1 | Weather before | [0, 0, 0] | 1F_1 | PLS | Number of | Average number | 0.24 | | Number | Average number | 0.32 | |
| | and after target | | | regression | passing | of people passing | | | of passing | of people passing | | |
| | day | | | | northward | northward | | | southward | southward | | |
| 2 | Holiday and | [0, 0, 0] | 2F_1 | Logistic | Number of | Average number | 0.54 | | Number | Average number | 0.75 | |
| | weekday before | | | regression | passing | of people passing | | | of passing | of people passing | | |
| | and after target | | | | northward | northward | | | southward | southward | | |
| | day | | | | | | | | | | | |
| 3 | Weather before | [0, 0, 1] | 1F_1 | SVR | Number of | Average number | −0.38 | | Number | Average number | 0.26 | |
| | and after target | | | | passing | of people passing | | | of passing | of people passing | | |
| | day | | | | northward | southward | | | southward | southward | | |
| 4 | Weather before | [0, 2, 2] | 1F_1 | PLS | Number of | Average number | 0.27 | | Number | Average number | 0.50 | |
| | and after target | | | regression | passing | of people passing | | | of passing | of people passing | | |
| | day | | | | northward | northward | | | southward | southward | | |

As described above, according to the people flow prediction device 100 of the present embodiment, it is possible to robustly predict a people flow in response to changes in space.

Further, according to the technique of the present disclosure, even in a space that changes variously and where people come and go in various directions and speeds depending on the date and time, it is possible to predict, one day or more in advance, the number of people passing or the average speed, after a time period in each direction in each area. As a result, the technique of the present disclosure can be useful for the maintenance, management, and operation of a commercial facility or the like, such as in air conditioning control, optimization of product purchase, and formulation of maintenance plans, which are performed in daily life.

Further, the present disclosure is not limited to the embodiments described above and various modifications and applications are possible without departing from the gist of the present disclosure.

For example, in a case in which each of the sets of features satisfy predetermined conditions, the data may be adopted as training data without cross-validation.

Further, for example, when the error a(i) satisfies a predetermined value, each of the features of the sets used to find the error a(i) may be adopted as the training data.

Further, for example, the error a(i) may be calculated by a test method other than cross-validation.

Note that the people flow calculation processing and the people flow prediction processing which are performed by causing the CPU to read and execute the software (program) in the above-described embodiments may be executed by various processors other than the CPU. Examples of the processor in such a case include a programmable logic device (PLD) the circuit configuration of which can be changed after manufacturing such as a field-programmable gate array (FPGA), a dedicated electric circuit such as an application specific integrated circuit (ASIC) that is a processor having a circuit configuration designed dedicatedly for executing the specific processing, and the like. Further, the people flow calculation processing and the people flow prediction processing may be performed by one of these various processors or a combination of two or more processors of the same type or different types (such as, for example, a combination of a plurality of FPGAs and a combination of a CPU and an FPGA). More specifically, the hardware structure of such various processors is an electrical circuit obtained by combining circuit elements such as semiconductor elements.

Further, in the embodiments described above, an aspect has been described in which the people flow calculation program and the people flow prediction program are stored (installed) in advance in the storage 14, but the present disclosure is not limited thereto. The program may be provided in the form of being stored in a non-transitory storage medium such as a compact disk read only memory (CD-ROM), a digital versatile disk read only memory (DVD-ROM), or a universal serial bus (USB) memory. The program may be in a form that is downloaded from an external apparatus via a network.

With respect to the above embodiment, the following supplements are further disclosed.

Supplementary Item 1

A people flow prediction device including
a memory, and at least one processor connected to the memory,
in which the processor
selects, in accordance with a prediction condition including a target prediction period subject to prediction, training data related to people flow data of a plurality of dates and times corresponding to the target prediction period,
trains, in accordance with the training data being selected, and stores, in a model storage unit, a prediction model having a predetermined feature and for predicting people flow data of a predetermined date and time, and
selects the prediction model from the model storage unit in accordance with the prediction condition and a permission condition related to a feature of the prediction model, and predicts people flow data under the prediction condition in accordance with the prediction model being selected.

Supplementary Item 2

A non-transitory storage medium configured to store a computer-executable program for people flow prediction processing, the non-transitory storage medium being configured to
select, in accordance with a prediction condition including a target prediction period subject to prediction, training data related to people flow data of a plurality of dates and times corresponding to the target prediction period,
train, in accordance with the training data being selected, and store, in a model storage unit, a prediction model having a predetermined feature and for predicting people flow data of a predetermined date and time, and
select the prediction model from the model storage unit in accordance with the prediction condition and a permission condition related to a feature of the prediction model, and predict people flow data under the prediction condition in accordance with the prediction model being selected.

### REFERENCE SIGNS LIST

100 People flow prediction device
101 People flow calculation unit
102 People flow data storage unit
103 Training data selection unit
104 Model storage unit
104 Prediction model creation unit
105 Model storage unit
106 Prediction unit
110 Operation terminal
120 People flow measurement means
121 Trajectory data storage device
122 Calculation setting value
123 Data selection setting value
124 Model creation setting value
125 Prediction command
126 External information
127 Prediction result

1. A people flow prediction device comprising a processor configured to execute a method comprising:
selecting, in accordance with a prediction condition including a target prediction period subject to prediction, training data related to pieces of people flow data of a plurality of dates and times corresponding to the target prediction period;
training, in accordance with the training data being selected, a prediction model having a predetermined feature and for predicting people flow data of a predetermined date and time;
storing the prediction model;
selecting the prediction model in accordance with the prediction condition and a permission condition related to a feature of the prediction model; and
predicting people flow data under the prediction condition in accordance with the prediction model being selected.

2. The people flow prediction device according to claim 1, wherein
the permission condition is defined for a distance of a feature vector related to days before and after included in the prediction model corresponding to the prediction condition, and
when the prediction model satisfying the prediction condition and the permission condition does not exist, the training data are selected and the prediction model is trained.

3. The people flow prediction device according to claim 1, wherein the selecting further comprises:
calculating a feature vector of δ days before and after a target prediction day,
acquiring, from among the pieces of people flow data, people flow data of δ days before and after corresponding to the feature vector related to the δ days before and after the target prediction day being calculated, and external information corresponding to the people flow data,
calculating a feature of a set of the people flow data of the δ days before and after being acquired and the external information being acquired, and
selecting, as the training data, the feature vector of the δ days before and after and the feature of the set.

4. The people flow prediction device according to claim 3, wherein the selecting further comprises:
incrementing the δ days before and after,
dividing each feature of the set into for evaluation and for model creation to implement cross-validation, and
selecting, as training data, from among the δ days before and after, each feature of the set reducing an error to be obtained.

5. The people flow prediction device according to claim 1, wherein the prediction condition includes a calculation interval, an area subject to prediction, a direction, and a target indicating the number of people traveling or a travel speed to be predicted.

6. The people flow prediction device according to claim 1, the processor further configured to execute a method comprising:
calculating the people flow data as a statistical value of the number of people traveling per direction basis or a travel speed per direction basis, in accordance with trajectory data including coordinates for every time points of a traveling target and a calculation setting value including a direction rule and a type of calculation target.

7. A computer implemented method for predicting a people flow, comprising:
selecting, in accordance with a prediction condition including a target prediction period subject to prediction, training data related to people flow data of a plurality of dates and times corresponding to the target prediction period;
training, in accordance with the training data being selected, and storing a prediction model having a predetermined feature and for predicting people flow data of a predetermined date and time;
selecting the prediction model in accordance with the prediction condition and a permission condition related to a feature of the prediction model; and
predicting people flow data under the prediction condition in accordance with the prediction model being selected.

8. A computer-readable non-transitory recording medium storing computer-executable program instructions that when executed by a processor cause a computer to execute a method comprising:
selecting, in accordance with a prediction condition including a target prediction period subject to prediction, training data related to people flow data of a plurality of dates and times corresponding to the target prediction period;
training, in accordance with the training data being selected, a prediction model having a predetermined feature and for predicting people flow data of a predetermined date and time;
storing the prediction model;
selecting the prediction model in accordance with the prediction condition and a permission condition related to a feature of the prediction model; and
predicting people flow data under the prediction condition in accordance with the prediction model being selected.

9. The people flow prediction device according to claim 2, wherein the prediction condition includes a calculation interval, an area subject to prediction, a direction, and a target indicating the number of people traveling or a travel speed to be predicted.

10. The computer implemented method according to claim 7,
wherein
the permission condition is defined for a distance of a feature vector related to days before and after included in the prediction model corresponding to the prediction condition, and
when the prediction model satisfying the prediction condition and the permission condition does not exist, the training data are selected and the prediction model is trained.

11. The computer implemented method according to claim 7, wherein the selecting further comprises:
calculating a feature vector of δ days before and after a target prediction day,
acquiring, from among the pieces of people flow data, people flow data of δ days before and after corresponding to the feature vector related to the δ days before and after the target prediction day being calculated, and external information corresponding to the people flow data,
calculating a feature of a set of the people flow data of the δ days before and after being acquired and the external information being acquired, and
selecting, as the training data, the feature vector of the δ days before and after and the feature of the set.

12. The computer implemented method according to claim 11, wherein the selecting further comprises:
incrementing the δ days before and after,
dividing each feature of the set into for evaluation and for model creation to implement cross-validation, and
selecting, as training data, from among the δ days before and after, each feature of the set reducing an error to be obtained.

13. The computer implemented method according to claim 7, wherein the prediction condition includes a calculation interval, an area subject to prediction, a direction, and a target indicating the number of people traveling or a travel speed to be predicted.

14. The computer implemented method according to claim 7, the method further comprising:
calculating the people flow data as a statistical value of the number of people traveling per direction basis or a travel speed per direction basis, in accordance with trajectory data including coordinates for every time points of a traveling target and a calculation setting value including a direction rule and a type of calculation target.

15. The computer implemented method according to claim 10, wherein the prediction condition includes a calculation interval, an area subject to prediction, a direction, and a target indicating the number of people traveling or a travel speed to be predicted.

16. The computer-readable non-transitory recording medium according to claim 8, wherein
the permission condition is defined for a distance of a feature vector related to days before and after included in the prediction model corresponding to the prediction condition, and
when the prediction model satisfying the prediction condition and the permission condition does not exist, the training data are selected and the prediction model is trained.

17. The computer-readable non-transitory recording medium according to claim 8, wherein the selecting further comprises:
calculating a feature vector of δ days before and after a target prediction day,
acquiring, from among the pieces of people flow data, people flow data of δ days before and after corresponding to the feature vector related to the δ days before and after the target prediction day being calculated, and external information corresponding to the people flow data,
calculating a feature of a set of the people flow data of the δ days before and after being acquired and the external information being acquired, and
selecting, as the training data, the feature vector of the δ days before and after and the feature of the set.

18. The computer-readable non-transitory recording medium according to claim 17, wherein the selecting further comprises:
incrementing the δ days before and after,
dividing each feature of the set into for evaluation and for model creation to implement cross-validation, and
selecting, as training data, from among the δ days before and after, each feature of the set reducing an error to be obtained.

19. The computer-readable non-transitory recording medium according to claim 8, wherein the prediction condition includes a calculation interval, an area subject to prediction, a direction, and a target indicating the number of people traveling or a travel speed to be predicted.

20. The computer-readable non-transitory recording medium according to claim 8, the computer-executable program instructions when executed further cause the computer to execute a method comprising:
calculating the people flow data as a statistical value of the number of people traveling per direction basis or a travel speed per direction basis, in accordance with trajectory data including coordinates for every time points of a traveling target and a calculation setting value including a direction rule and a type of calculation target.
